(19) United States
(12) Patent Application Publication
(10) Pub. No.: US 2017/0277925 A1
(43) Pub. Date: Sep. 28, 2017

(54) Method and Terminal for Scanning

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/298,534

(22) Filed: Oct. 20, 2016

Related U.S. Application Data
(63) Continuation of application No. PCT/CN2016/096272, filed on Aug. 22, 2016.

(30) Foreign Application Priority Data
Mar. 25, 2016 (CN) 2016101804790

(51) Int. Cl. G06K 7/14; G06K 7/10

(52) U.S. Cl. CPC G06K 7/1439; G06K 7/10841; G06K 7/1408

(57) ABSTRACT

Disclosed are a method and terminal for scanning. The method for scanning of the terminal, provided by the embodiments of the present disclosure, includes: monitoring whether the terminal opens a bar code identification function or not; if monitoring that the bar code identification function of the terminal is opened, scanning a bar code by utilizing an edge touch area of the terminal; and executing a corresponding operation according to the scanned bar code. The technical solution provided by the embodiments of the present disclosure is used for solving the problems that long time consumption and low bar code scanning efficiency existed in the prior art, which is caused by the bar code being scanned using the camera, the camera needs to be focused first and then the bar code is acquired.

### CROSS REFERENCE TO RELATED APPLICATIONS

This application is a continuation of International Application No. PCT/CN2016/096272, filed Aug. 22, 2016, and claims priority to Chinese Patent Application No. 2016101804790, filed Mar. 25, 2016, the disclosures of which are hereby incorporated in their entirety by reference.

### TECHNICAL FIELD

The present disclosure relates to the technical field of communications, and particularly relates to a method and terminal for scanning.

### BACKGROUND

With the development of science and technology and the progress of technology, the use of intelligent terminals is becoming more and more popular. In order to improve use efficiency and enhance user's experience, the existing intelligent terminal has more and more functions, e.g., payment, scanning and the like.

A scanning function of a terminal used by a user is mostly achieved via a camera on the terminal, and then corresponding information is obtained after scanned information is analyzed. For example, the camera is used to scan a two-dimensional code on an outer package of an article so as to obtain a website address related to the article.

In the process of implementing the present disclosure, the inventor finds that at least the following problem exists in the prior art: in the prior art, when a bar code is scanned by using the camera, the camera needs to be focused first and then acquires the bar code, and thus, long time is consumed and bar code scanning efficiency is low.

### SUMMARY

In view of this, the present disclosure provides a method and terminal for scanning, which are used for solving the problem that long time consumption and low bar code scanning efficiency are caused as in the prior art, when a bar code is scanned by using a camera, the camera needs to be focused first and then the bar code is acquired.

In order to realize the aim of the present disclosure, according to one aspect, an embodiment of the present disclosure provides a method for scanning, including: monitoring whether the terminal opens a bar code identification function or not; scanning a bar code by utilizing an edge touch area of the terminal if it is monitored that the terminal open a bar code identification function; and executing a corresponding operation according to the scanned bar code.

According to the aspect mentioned above and any possible implementation way, an implementation way is further provided, and the edge touch area of the terminal includes an edge touch area of at least one side surface of the terminal.

According to the aspect mentioned above and any possible implementation way, an implementation way is further provided, and the scanning the bar code by utilizing the edge touch area of the terminal includes: emitting light ray by the edge touch area of the terminal so that the light ray irradiates the bar code to be scanned.

According to the aspect mentioned above and any possible implementation way, an implementation way is further provided, and the executing the corresponding operation according to the scanned bar code includes: receiving, by utilizing the edge touch area of the terminal, light ray reflected back after the light ray irradiates the bar code; decoding the reflected light ray so as to obtain a digital signal; and executing the corresponding operation according to the digital signal obtained after decoding.

According to the aspect mentioned above and any possible implementation way, an implementation way is further provided, and the bar code includes: a one-dimensional code or a two-dimensional code.

In the method for scanning of the terminal, provided by the embodiment of the present disclosure, after monitoring that the terminal open the bar code identification function, the bar code can be scanned by utilizing the edge touch area of the terminal, and when the bar code is scanned by utilizing the edge touch area, focusing is not required, thereby the problem can be solved that long time consumption and low bar code scanning efficiency existed in the prior art, which is caused by the bar code is scanned using the camera, the camera needs to be focused first and then the bar code is acquired. Therefore, rapid and effective scanning and identification of the bar code are achieved, and efficiency of scanning the bar code by utilizing the terminal is improved.

In order to realize the aim of the present disclosure, according to the next aspect, an embodiment of the present disclosure provides a terminal, including: at least one processor; and a memory connected with the at least one processor in a communication way, wherein instructions executable by the at least one processor are stored in the memory, and are executed by the at least one processor, so that the at least one processor executes the method according to all the aspects above.

In order to realize the aim of the present disclosure, according to the next aspect, an embodiment of the present disclosure provides a computer program product. The computer program product includes a computer program stored on a nonvolatile computer-readable storage medium, the computer program includes program instructions, and when the program instructions are executed by a computer, the computer executes the method according to all the aspects above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of embodiment 1 of a method for scanning provided by some embodiments of the present disclosure.

FIG. 2 is a flow chart of embodiment 2 of a method for scanning provided by some embodiments of the present disclosure;

FIG. 3 is a structural schematic diagram of a terminal provided by some embodiments of the present disclosure;

FIG. 4 is a structural schematic diagram of hardware of a terminal provided by some embodiments of the present disclosure.

### DETAILED DESCRIPTION

The preferable embodiments of the present disclosure will be illustrated below in conjunction with the accompanying drawings. It should be understood that the preferable embodiments described herein are only intended to illustrate and explain the present disclosure, but not limit the present disclosure.

It is clear that the described embodiments are just a part but not all of the embodiments of the present disclosure. On the basis of the embodiments of the present disclosure, all other embodiments obtained by those of ordinary skill in the art without creative efforts are within the protection scope of this application.

The terms used in the embodiments of the present disclosure are merely for the purpose of describing specific embodiments rather than limiting the present disclosure. The singular forms “a”, “said” and “the” used in the embodiments and the attached claims of the present disclosure also aim to include plural forms unless the context clearly expresses other meanings.

Depending on the context, the word “if”, for example, used herein may be interpreted as “at the time of” or “when” or “in response to determination” or “in response to detection”. Similarly, depending on the context, the phrase “if determining” or “if detecting (stated conditions or events)” may be interpreted as “when determining” or “in response to determination” or “when detecting (stated conditions or events)” or “in response to detection (stated conditions or events)”.

### Embodiment 1

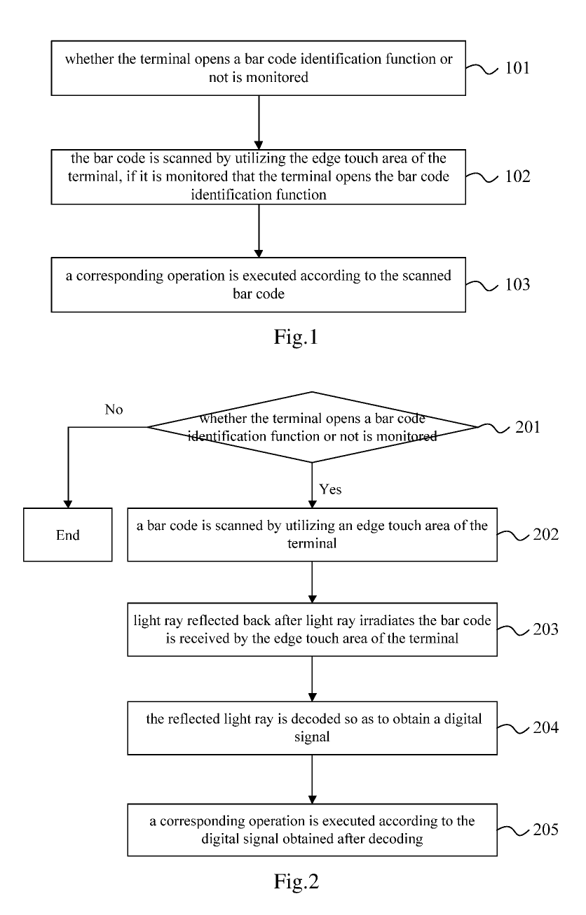

FIG. 1 is a flow chart of embodiment 1 of a method for scanning provided by the embodiment. As shown in FIG. 1, the method for scanning of the terminal provided by the embodiment particularly can include the following steps.

101, whether the terminal opens a bar code identification function or not is monitored.

In daily life, there are a great number of bar codes, e.g., on each article in a supermarket, a bar code representing price information, or a bar code representing personal information, or a bar code representing a production batch number, or the like. If a user wants to know information represented by a bar code, the user needs to scan the bar code by means of a scanning tool, e.g., a scanning gun and other scanning device for scanning the bar codes in the supermarket, so as to obtain the information represented by the bar code.

In order to achieve convenience in use and portability, a camera in the terminal can be utilized to replace the scanning device to scan the bar code. However, the camera consumes long time in the focusing process, so it is likely to generate a phenomenon of focusing failure so as to cause low scanning efficiency.

Therefore, in the embodiment of the present disclosure, an edge touch area of the terminal is utilized to scan the bar code, and the bar code can be scanned by only opening the bar code identification function of the terminal. In order to detect whether the bar code identification function of the terminal is opened or not, an operation in the terminal needs to be monitored so as to determine that the bar code identification function is in an open state when the bar code needs to be scanned. For example, the bar code identification function can be opened either in the application or in setting functions of the terminal.

It should be noted that the terminal involved in the embodiment of the present disclosure can include, but not be limited to, a Personal Computer (PC), a Personal Digital Assistant (PDA), a wireless handheld device, a Tablet Computer, a mobile phone, an MP3 player, an MP4 player and the like, and the terminal is provided with a screen.

102, the bar code is scanned by utilizing the edge touch area of the terminal, if it is monitored that the terminal opens the bar code identification function.

After the terminal open the bar code identification function, a monitoring module in the terminal monitors that the bar code identification function of the terminal is opened, and then scanning is started in a manner that light ray is emitted by the edge touch area of the terminal and irradiates the bar code to be scanned.

In one specific implementing process, an apparatus for emitting the light ray can be an infrared emitter, a laser emitter or a Charge Coupled Device (CCD) sensor or the like. The apparatus for emitting the light ray can be preinstalled in the edge touch area of the terminal to emit the light ray by the edge touch area of the terminal after the bar code identification function is opened, so that the emitted light ray irradiates the bar code to be scanned.

For example, when the edge touch area where the infrared emitter is installed and is used for scanning a bar code, infrared rays can be emitted, the infrared rays irradiate the bar code, and then the reflected light ray is received by the edge touch area of the terminal so as to complete scanning on the bar code.

For another example, when the edge touch area where the laser emitter is installed is used for scanning a bar code, laser can be emitted, the laser irradiates the bar code, and then the reflected light ray is received by the edge touch area of the terminal so as to complete scanning on the bar code.

It should be noted that the edge touch area of the terminal can be a area on a side surface of the terminal, which can be reached by a thumb of a user when the user naturally holds the terminal, and the sides of the terminal can include other four sides except for a front surface and a back surface.

In the embodiment of the present disclosure, the edge touch area includes an edge touch area on at least one side surface of the terminal.

103, a corresponding operation is executed according to the scanned bar code.

After the edge touch area of the terminal receives the light ray reflected via the bar code, the light ray is converted into a digital signal via optical signal analysis, so as to directly display information represented by the bar code in the screen of the terminal or in certain software in the terminal.

For example, when the edge touch area of the terminal is used to scan a bar code representing a production batch number, after the edge touch area of the terminal emits the light ray to irradiate the bar code, the reflected light ray is received via the edge touch area of the terminal, an optical signal is converted into a digital signal, and software of the terminal obtains the production batch number represented by the bar code according to the digital signal.

In the method for scanning of the terminal, provided by the embodiment of the present disclosure, after monitoring that the terminal open the bar code identification function, the bar code can be scanned by utilizing the edge touch area of the terminal, and when the bar code is scanned by utilizing the edge touch area, focusing is not required, thereby the problem can be solved that long time consumption and low bar code scanning efficiency existed in the prior art, which is caused by the bar code being scanned using the camera, the camera needs to be focused first and then the bar code is acquired. Therefore, rapid and effective scanning and identification of the bar code are achieved, and efficiency of scanning the bar code by utilizing the terminal is improved.

### Embodiment 2

FIG. 2 is a flow chart of embodiment 2 of a method for scanning provided by the embodiment of the present disclosure. As shown in FIG. 2, the method for scanning of the terminal of the embodiment specifically can include the following steps.

201, whether the terminal opens a bar code identification function or not is monitored, if it is monitored that the terminal open the bar code identification, step 201 is executed, or the procedure is ended if it is not monitored that the bar code identification of the terminal is opened.

With respect to the process that a monitoring module in the terminal monitors that the bar code identification function of the terminal is opened, refer to description in step 101 in embodiment 1 for details. The principle and implementing process of the process in the embodiment of the present disclosure are the same as those in embodiment 1, and will not be repeated herein.

If the monitoring module in the terminal does not monitor that the bar code identification function is opened, the procedure is ended, and the monitoring module will further monitor whether the bar code identification function of the terminal is opened or not.

202, a bar code is scanned by utilizing an edge touch area of the terminal.

With respect to the process of how to scan the bar code by utilizing the edge touch area of the terminal, refer to description in step 102 in embodiment 1 for details. The principle and implementing process of the process in the embodiment of the present disclosure are the same as those in embodiment 1, and will not be repeated herein.

203, the light ray reflected back after the light ray irradiates the bar code is received by the edge touch area of the terminal.

After the bar code identification function in the terminal is opened, the bar code to be scanned is placed in a scanning area, the edge touch area of the terminal starts emitting the light ray, and after the light ray irradiates the bar code, the reflected light ray is received via the edge touch area of the terminal. For example, when the edge touch area where the infrared emitter is installed is used for scanning a bar code, an infrared ray can be emitted, the infrared ray irradiates the bar code, and then the reflected light ray is received by the edge touch area of the terminal.

204, the reflected light ray is decoded so as to obtain a digital signal.

After the edge touch area of the terminal receives the reflected light ray, that is, the terminal obtains the optical signal, the reflected light ray form image on a photoelectric converter via an optical system in the terminal so as to generate an electric signal; after the electric signal is amplified via a circuit, an analog signal in direct proportion to the received optical signal is generated; then a square signal corresponding to the analog signal is formed through filtering and shaping; and the square signal is interpreted by a decoder into a digital signal which can be processed by the terminal.

For example, when the edge touch area where a laser emitter is installed is used for scanning a bar code representing user information, laser is emitted by the laser emitter and reaches the bar code; after the reflected light ray is received by the edge touch area of the terminal, an optical signal is converted into an electric signal via the photoelectric converter; and finally, the electric signal is interpreted by the decoder into a digital signal which can be processed by the terminal.

205, a corresponding operation is executed according to the digital signal obtained after decoding.

The terminal executes the corresponding operation according to the digital signal obtained after decoding in step 204.

For example, when holding the terminal with the bar code identification function in a shopping place, a user can utilize the edge touch area of the terminal to scan a bar code of an article to be purchased to obtain price of the article, and then utilize software with a payment function in the terminal to carry out payment.

Or, the user also can utilize the terminal with the bar code identification function to scan a bar code including specific information to obtain contents stored in the bar code and trigger a related application.

For example, after a user scans a bar code printed on newspaper by using the edge touch area of the terminal and light ray emitted in the edge touch area irradiates the bar code, the reflected light ray is received via the terminal and is finally converted into a digital signal, a website address can be obtained according to the digital signal, and then the website address is opened for browsing by utilizing a browser.

In the method for scanning of the terminal, provided by the embodiment of the present disclosure, after monitoring that the terminal open the bar code identification function, the bar code can be scanned by utilizing the edge touch area of the terminal, and when the bar code is scanned by utilizing the edge touch area, focusing is not required, thereby the problem can be solved that long time consumption and low bar code scanning efficiency existed in the prior art, which is caused by the bar code being scanned using the camera, the camera needs to be focused first and then the bar code is acquired. Therefore, rapid and effective scanning and identification of the bar code are achieved, and efficiency of scanning the bar code by utilizing the terminal is improved.

### Embodiment 3

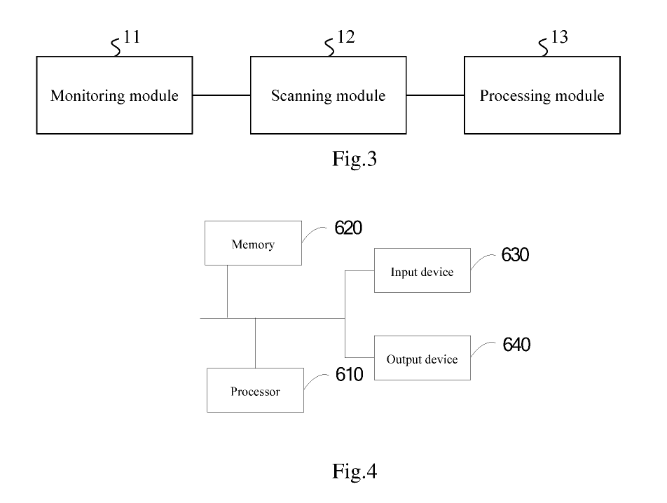

The embodiment of the present disclosure further provides a device embodiment for implementing each step and method in the method embodiments. FIG. 3 is a structural schematic diagram of a terminal provided by the embodiment of the present disclosure. As shown in FIG. 3, the terminal provided by the embodiment of the present disclosure includes: a monitoring module 11, a scanning module 12 and a processing module 13.

The monitoring module 11 is used for monitoring whether the terminal opens a bar code identification function or not.

The scanning module 12 is used for scanning a bar code by utilizing an edge touch area of the terminal if the monitoring module 11 monitors that the bar code identification function of the terminal is opened.

The processing module 13 is used for executing a corresponding operation according to the bar code scanned by the scanning module 12.

The edge touch area of the terminal includes an edge touch area on at least one side surface of the terminal.

In one possible implementation way, the scanning module 12 is particularly used for: emitting the light ray by the edge touch area of the terminal so that the light ray irradiates the bar code to be scanned.

In one possible implementation way, the processing module 13 is particularly used for: receiving, by utilizing the edge touch area of the terminal, the light ray reflected back after the light ray irradiates the bar code; decoding the reflected light ray so as to obtain a digital signal; and executing the corresponding operation according to the digital signal obtained after decoding.

It should be noted that the bar code includes: a one-dimensional code or a two-dimensional code.

The terminal in accordance with the embodiment of the present disclosure can be used for executing the technical solution of the method embodiment shown in FIG. 1 or FIG. 2, and the implementing principle and technical effects are similar to those of aforementioned embodiments, which are not repeated herein.

According to the terminal provided by the embodiment of the present disclosure, whether the bar code identification function of the terminal is opened or not is monitored by the monitoring module 11, the scanning module 12 scans the bar code by utilizing the edge touch area of the terminal when the monitoring module 11 monitors that the bar code identification function of the terminal is opened, and finally, the corresponding operation is executed by the processing module 13 according to the scanned bar code. When the bar code is scanned by utilizing the edge touch area, focusing is not required, thereby solving the problem that long time consumption and low bar code scanning efficiency are caused as in the prior art, when the bar code is scanned by using a camera, the camera needs to be focused first and then the bar code is acquired. Therefore, rapid and effective scanning and identification on the bar code are achieved, and efficiency of scanning the bar code by utilizing the terminal is improved.

### Embodiment 4

The embodiment of the present disclosure provides a nonvolatile computer storage medium, which stores computer executable instructions that can execute the processing method in any method embodiments mentioned above.

### Embodiment 5

FIG. 4 is a structural schematic diagram of hardware of a terminal provided by the embodiment. As shown in FIG. 4, the terminal includes one or a plurality of processors 610 and a memory 620. In FIG. 4, one processor 610 is taken as an example. The terminal further can include: an input device 630 and an output device 640.

The processor 610, the memory 620, the input device 630 and the output device 640 can be connected via a bus or in other modes. In FIG. 4, the connection via the bus is taken as an example.

The memory 620, as a nonvolatile computer readable storage medium, can be used for storing a nonvolatile software program, a nonvolatile computer executable program and modules. The processor 610 runs the nonvolatile software program, the instruction and the modules stored in the memory 620 to execute various function applications and data processing of electronic equipment, thereby realizing the processing method of the method embodiments mentioned above

The memory 620 can include a program storage area and a data storage area, wherein the program storage area can store an operation system and an application required by at least one function; and the data storage area can store data and the like. In addition, the memory 620 can include a high-speed random access memory, and further can include a nonvolatile memory, e.g., at least one disk storage device, a flash memory device or other nonvolatile solid-state storage devices. In some embodiments, the memory 620 optionally includes memories remotely arranged relative to the processor 610, and those remote memories can be connected to a processing device by a network. Examples of the above network include, but are not limited to, Internet, an intranet, a local area network, a mobile communication network and combinations thereof.

The input device 630 can receive input numerical or character information, and generate a signal input. The output device 640 can include a display screen and other display devices.

The one or more modules are stored in the memory 620, and when being executed by the one or more processors 610, the one or more modules execute following operations: monitoring whether the terminal opens a bar code identification function or not; if it is monitored that the bar code identification function of the terminal is opened, scanning a bar code by utilizing an edge touch area of the terminal; and executing a corresponding operation according to the scanned bar code.

In one possible implementation way, the edge touch area of the terminal includes an edge touch area of at least one side surface of the terminal.

In one possible implementation way, the scanning the bar code by utilizing the edge touch area of the terminal includes: emitting light ray by the edge touch area of the terminal so that the light ray irradiates the bar code to be scanned.

In one possible implementation way, the executing a corresponding operation according to the scanned bar code includes: receiving, by utilizing the edge touch area of the terminal, the light ray reflected back after the light ray irradiates the bar code; decoding the reflected light ray so as to obtain a digital signal; and executing the corresponding operation according to the digital signal obtained after decoding.

In one possible implementation way, the bar code includes: a one-dimensional code or a two-dimensional code.

The above products can execute the method provided by the embodiments of the present disclosure, and have corresponding functional modules and beneficial effects for execution of the method. Technical details which are not described in detail in the embodiment can refer to the method provided by the embodiments of the present disclosure.

The electronic equipment in accordance with the embodiment of the present disclosure exists in various forms, and includes, but is not limited to:

Mobile communication equipment: this type of equipment is characterized by having a mobile communication function, and mainly aims to provide voice and data communication. This type of terminals include: a smart phone (e.g., iPhone), a multimedia mobile phone, a functional mobile phone, a low-end mobile phone and the like.

Ultra mobile personal computer equipment: this type of equipment is within the scope of personal computers, has calculating and processing functions, and commonly also has the characteristic of mobile internet access. This type of terminals include: PDA, MID, UMPC equipment and the like, e.g., iPad.

Portable entertainment equipment: this type of equipment can display and play multimedia contents. This type of equipment includes: an audio and video player (e.g., iPod), a handheld game player, a handheld game console, an electronic book, an intelligent toy and a portable vehicle-mounted navigation device.

A server: the server is a device for providing computing services, and includes a processor, a hard disk, a memory, a system bus and the like in structure, the server is similar with a general-purpose computer architecture, but as high-reliability services need to be provided, the server has higher requirements on the aspects of processing capacity, stability, reliability, safety, expandability, manageability and the like.

Other electronic devices with a data interaction function.

The device embodiment described above is only illustrative, the units illustrated as separate parts therein may be or not be physically separated, and the parts presented as units may be or not be physical units, that is to say, the parts may be positioned at one place, or distributed to a plurality of network units. Part or all of the modules therein may be selected according to actual needs to achieve the purpose of the solution of the embodiment.

By virtue of the description of the embodiments mentioned above, those skilled in the art may clearly understand that each embodiment may be realized by virtue of software and a general hardware platform, and of course, may be realized by virtue of hardware. Based on such understanding, the technical solution mentioned above substantially or the part making contribution to related technologies may be embodied in the form of a software product, and the computer software product may be stored in a computer readable storage medium, for example ROM/RAM, a diskette, a compact disk, etc., including a plurality of instructions for enabling one computer device (which may be a personal computer, a server, a network device or the like) to execute each embodiment or the method described by some parts of the embodiments.

Finally, it should be noted that the embodiments mentioned above are only for illustrating rather than limiting the technical solution of this application; although this application is described in detail with reference to the embodiments mentioned above, those of ordinary skill in the art still can modify the technical solution recorded by the embodiments mentioned above, or equivalently substitute part of the technical features therein; and these modifications or substitutions do not make the essence of the corresponding technical solution depart from the spirit and scope of the technical solution of each embodiment of this application.

What is claimed is:

1. A method for scanning of a terminal executed by the terminal, the method comprising:
monitoring whether the terminal opens a bar code identification function or not;
scanning a bar code by utilizing an edge touch area of the terminal, if it is monitored that the terminal open a bar code identification function; and
executing a corresponding operation according to the scanned bar code.

2. The method according to claim 1, wherein the edge touch area of the terminal comprises an edge touch area of at least one side surface of the terminal.

3. The method according to claim 1, wherein the scanning the bar code by utilizing the edge touch area of the terminal comprises:
emitting a light ray by the edge touch area of the terminal so that the light ray irradiates the bar code to be scanned.

4. The method according to claim 3, wherein the executing a corresponding operation according to the scanned bar code comprises:
receiving, by utilizing the edge touch area of the terminal, a light ray reflected back after the light ray irradiates the bar code;
decoding the reflected light ray so as to obtain a digital signal; and
executing the corresponding operation according to the digital signal obtained after decoding.

5. The method according to claim 1, wherein the bar code comprises: a one-dimensional code or a two-dimensional code.

6. A terminal, comprising:
at least one processor; and
a memory connected with the at least one processor in a communication way, wherein, instructions executable by the at least one processor are stored in the memory, and the instructions are executed by the at least one processor to enable the at least one processor to:
monitor whether the terminal opens a bar code identification function or not;
scan a bar code by utilizing an edge touch area of the terminal, if it is monitored that the terminal open a bar code identification function; and
execute a corresponding operation according to the scanned bar code.

7. The terminal according to claim 6, wherein the edge touch area of the terminal comprises an edge touch area of at least one side surface of the terminal.

8. The terminal according to claim 7, wherein the instructions are executed by the at least one processor to enable the at least one processor to:
emit a light ray by the edge touch area of the terminal so that the light ray irradiates the bar code to be scanned.

9. The terminal according to claim 8, wherein the instructions are executed by the at least one processor to enable the at least one processor to:
receive, by utilizing the edge touch area of the terminal, a light ray reflected back after the light ray irradiates the bar code;
decode the reflected light ray so as to obtain a digital signal; and
execute the corresponding operation according to the digital signal obtained after decoding.

10. The terminal according to claim 7, wherein the bar code comprises: a one-dimensional code or a two-dimensional code.

11. A nonvolatile computer-readable storage medium storing computer executable instructions, wherein the computer executable instructions are used for:
monitoring whether the terminal opens a bar code identification function or not;
scanning a bar code by utilizing an edge touch area of the terminal, if it is monitored that the terminal open a bar code identification function; and
executing a corresponding operation according to the scanned bar code.

12. The nonvolatile computer-readable storage medium according to claim 11, wherein the edge touch area of the terminal comprises an edge touch area of at least one side surface of the terminal.

13. The nonvolatile computer-readable storage medium according to claim 12, wherein the computer executable instructions are used for:
emitting a light ray by the edge touch area of the terminal so that the light ray irradiates the bar code to be scanned.

14. The nonvolatile computer-readable storage medium according to claim 13, wherein the computer executable instructions are used for:
receiving, by utilizing the edge touch area of the terminal, a light ray reflected back after the light ray irradiates the bar code;
decoding the reflected light ray so as to obtain a digital signal; and
executing the corresponding operation according to the digital signal obtained after decoding.

15. The nonvolatile computer-readable storage medium according to claim 11, wherein the bar code comprises: a one-dimensional code or a two-dimensional code.
